(19) United States
(12) Patent Application Publication
(10) Pub. No.: US 2016/0095473 A1
(43) Pub. Date: Apr. 7, 2016

(54) MODULAR HERB GRINDER

(71) Applicant: Elevated Mechanics, LLC, Thornton, CO (US)

(72) Inventors: Evan Perucca, Denver, CO (US); Josh Bowman, Northglenn, CO (US); Jeff Carabelos, Thornton, CO (US)

(21) Appl. No.: 14/688,805

(22) Filed: Apr. 16, 2015

Related U.S. Application Data
(60) Provisional application No. 61/981,035, filed on Apr. 17, 2014.

(51) Int. Cl. A47J 42/14; B02C 19/00; A47J 42/42

(52) U.S. Cl. CPC A47J 42/14; A47J 42/42; B02C 19/00

(57) ABSTRACT

A modular herb grinder. The grinder may include cooperating grinding modules that define a chamber for grinding herbs or the like. The grinder may also include one or more integrated tools related to smoking and/or preparing an apparatus for smoking.

### RELATED APPLICATION

This application claims priority to U.S. Provisional Application No. 61/981,035 filed on Apr. 17, 2014 entitled “MODULAR HERB GRINDER,” the entirety of which is incorporated by reference herein.

### BACKGROUND

Many smokers of tobacco and other herb products use a number of tools and accessories to prepare for, engage in, and clean up after smoking. The processes and implements involved in smoking can depending on the type of smoker, the type of herb being smoked, the type of smoking device (e.g., pipe) being used, and/or other factors. For example, preparation for smoking can involve grinding the herb product (e.g., with an herb grinder tool), sifting the ground product, packing the ground product (e.g., with a press tool), installing a screen in the smoking device, clearing the smoke hole if clogged (e.g., using a reamer tool). The smoking can involve lighting a wick (i.e., which typically involves a lighter tool and wick material), which is used to light the smoking implement. The clean up after smoking can involve dumping out used product (e.g., including unburned product, sometimes called “dottle”), and scraping out and cleaning various portions of the smoking implement (e.g., the bowl, smoke hole, etc.) with reamers, scrapers, and/or other cleaning tools. In this regard, traditional tools for the purposes described above often involved a plurality of individual, dedicated tools.

### SUMMARY

In view of the foregoing, the present disclosure relates to embodiments of a tool for use in connection with smoking. The previously contemplated tools described above have tended to be available either as dedicated, single-use devices (e.g., a lighter, an herb grinder, etc.) or as repurposed devices (e.g., a screwdriver or dental implement being used as a reamer), the present disclosure include embodiments of a unitary tool that may facilitate one or more needs for a smoker. Similarly, the accessories (e.g., wicks, screens, etc.) contemplated to date have tended to be small and often delicate or unwieldy to transport. Smokers can find it inconvenient to carry around all these multiple accoutrements. Accordingly, smokers may desire to have convenient access to a variety of useful tools and accessories.

Accordingly, embodiments described herein include a modular herb grinder with integrated accessories. Implementations of the herb grinder include at least two grinding modules. Disengaging the grinding modules can provide access to a grinding chamber into which herb product can be placed. The grinding modules can then be rotatably engaged in a grinding configuration that permits rotating one grinding module with respect to the other in such a way that causes grinding elements in the two grinding modules to interact to grind the herb product disposed in the chamber. In certain implementations, the grinding modules can be further engaged in an idle configuration that substantially restricts movement of one module with respect to the other (i.e., when the grinder is not in use).

Various embodiments integrate one or more tools and/or accessories in one or more of the grinding modules. In one embodiment, a lighter compartment is integrated into one of the grinding modules. For example, the lighter compartment can be configured to securely hold a lighter (e.g., of a standard size, of a particular make and/or model, etc.), to provide access to the lighter mechanisms (e.g., to permit a user to activate the pump and flint of a lighter without removing the lighter from the compartment), etc. In another embodiment, one or more tools are integrated into one or more of the grinding modules in such a way that each tool can be selectively positioned in an idle (e.g., stored) and one or more use (e.g., exposed) configurations. For example, one of the grinding modules can include a set of tools (e.g., a reamer, a scraper, and a press), each rotatably coupled with the grinding module in a way that permits the tool to be stored at least partially within a body of the grinding module, exposed by pivoting a respective tool holder out from the body of the grinding module, and removed from its respective tool holder as desired. In still another embodiment, one or more accessory storage modules are integrated into one or more of the grinding modules. For example, one of the grinding modules can include a spool configured to hold an amount of wick material (e.g., with a port in the side of the grinding module through which wick material can be accessed from the spool), a screen holder configured to hold one or more screens, a reservoir configured to hold a quantity of herb product, an ash tray, and/or any other useful accessory. In some implementations, features of the integrated tools, integrated accessory storage modules, grinding modules, etc. can provide further integration features. For example, in one implementation, a screen holder is integrated into one of the grinding modules in such a way that, when installed, it acts as a stop to help prevent movement of the grinding modules relative to one another when in the idle configuration, it acts as a stop for limiting the range of rotation of the grinding modules relative to one another when in the grinding configuration, it acts as a cap for holding a wick spool in place, etc. These and other embodiments are described more fully herein.

### BRIEF DESCRIPTION OF THE DRAWINGS

In the following description, numerous specific details are set forth to provide a thorough understanding of various embodiments. However, one having ordinary skill in the art should recognize that the invention can be practiced without these specific details. In some instances, structures and techniques have not been shown in detail to avoid obscuring the present invention. Further the appended figures are intended to illustrate various features of certain implementations for added clarity and are not intended to limit the scope of embodiments.

FIGS. 1, 2A and 2B show various views of an implementation of a modular herb grinder having some of the various types of features described herein. For example, the modular herb grinder can include separable grinding modules with integrated lighter compartment, screen holder, wick spool and dispenser, and tool set. These and other features are described below. The illustrated implementation is intended to show how many different features can be integrated into a single embodiment, and is not intended to limit the number or types of integrations possible in other implementations.

FIG. 3 shows cross-sectional views of modules of a modular herb grinder embodiment to further illustrate certain features. For example, FIG. 3 further illustrates one implementation of the grinding mechanisms (e.g., teeth, chambers, etc.), integrated tool set, integrated lighter compartment, etc.

FIG. 4 shows an exploded view of an embodiment of a modular herb grinder to further illustrate certain features and to illustrate one approach to manufacturing the device.

FIGS. 5A and 5B show an illustrative integrated tool set, including reamer, press, and scraper tools.

### DETAILED DESCRIPTION

The following description is not intended to limit the invention to the forms disclosed herein. Consequently, variations and modifications commensurate with the following teachings, skill and knowledge of the relevant art, are within the scope of the present invention. The embodiments described herein are further intended to explain modes known of practicing the invention and to enable others skilled in the art to utilize the invention in such, or other embodiments and with various modifications required by the particular applications(s) or use(s) of the present invention.

Herb Grinder Embodiments

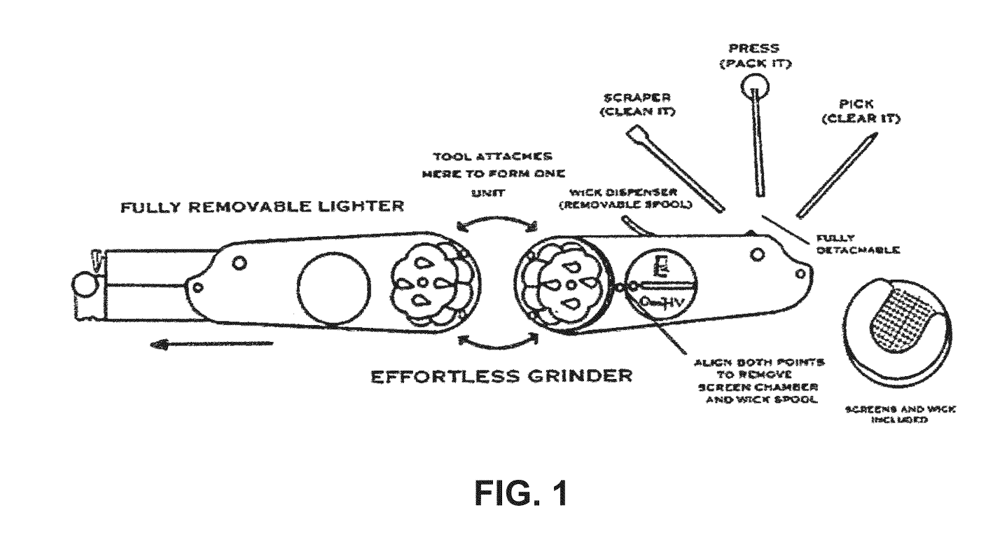

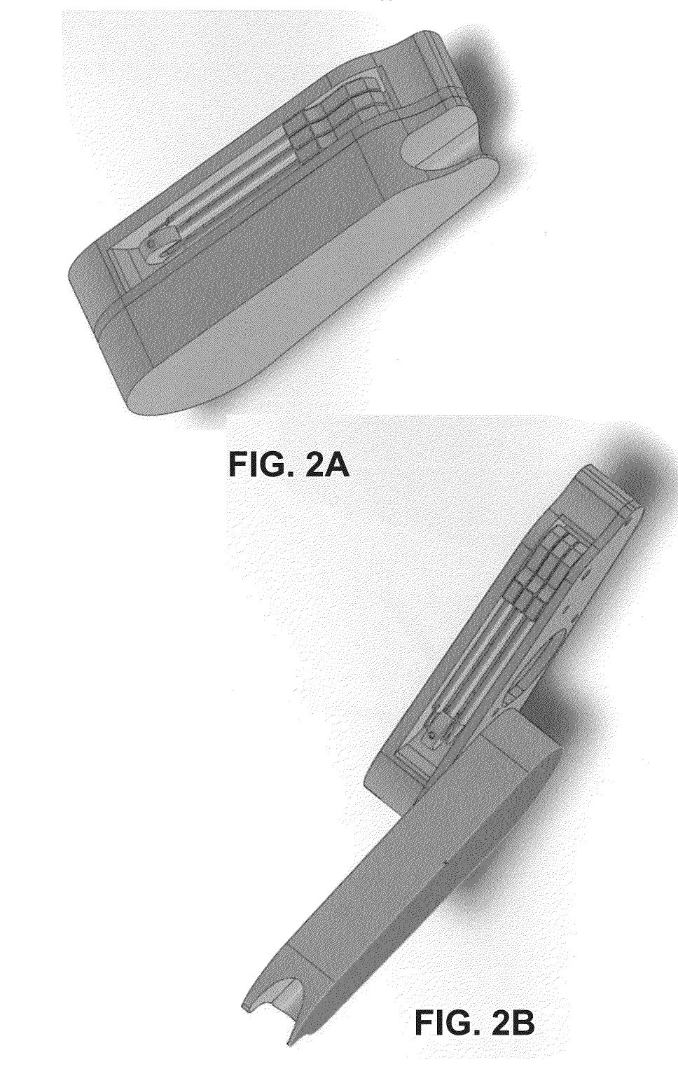

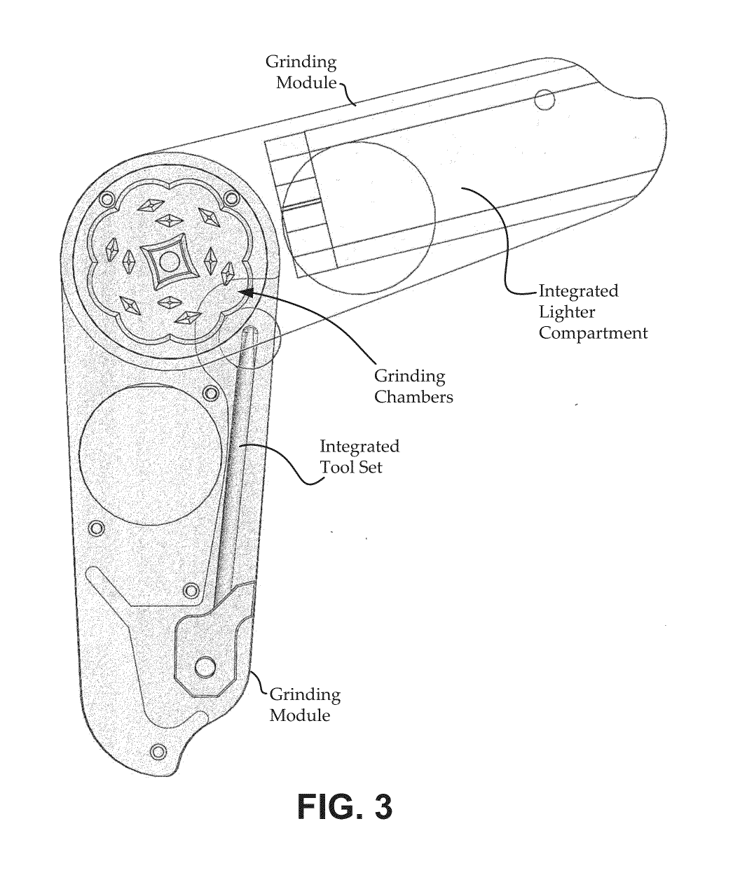

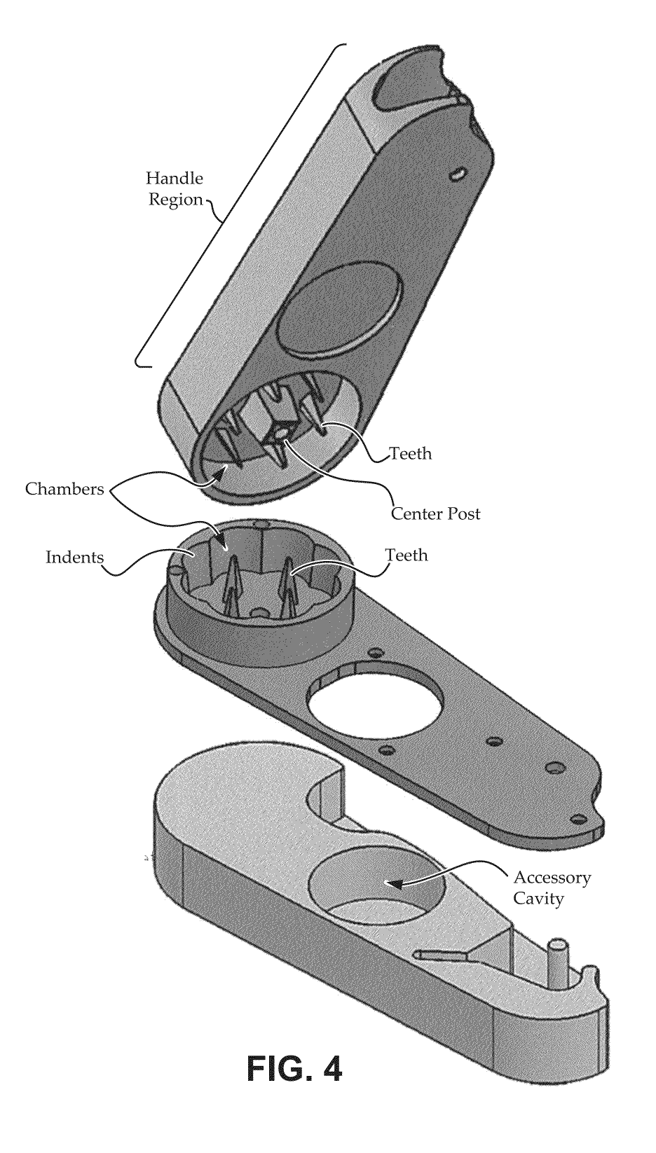

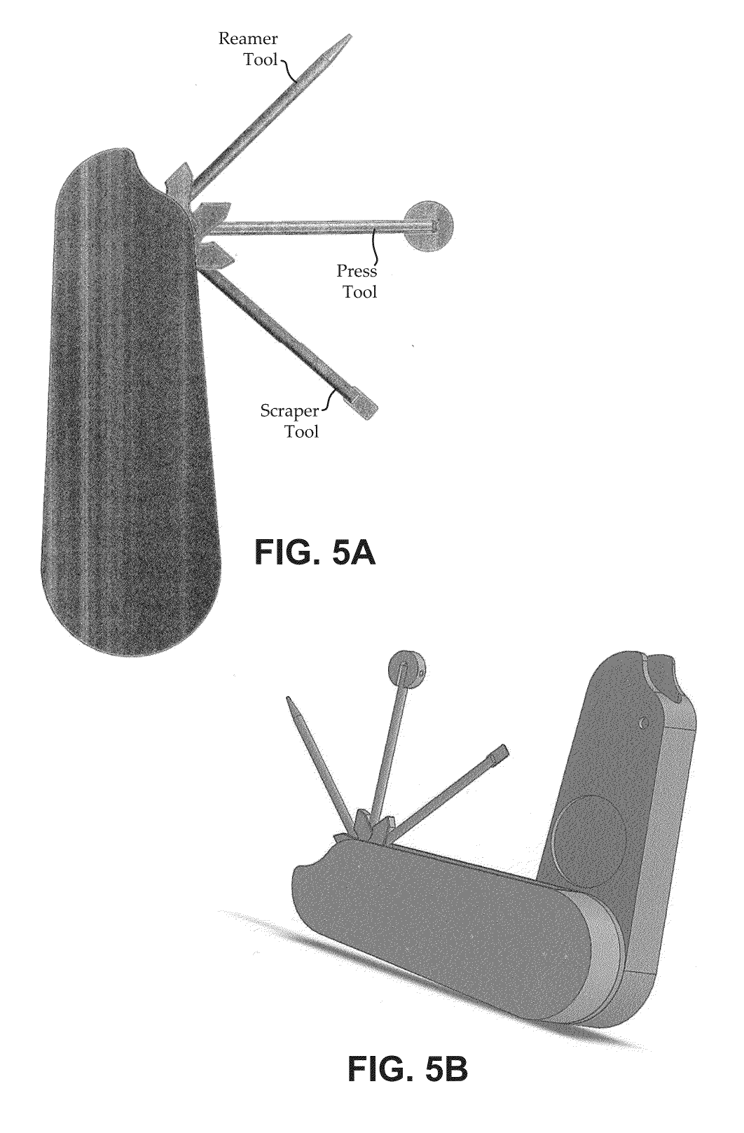

Implementations of the herb grinder can include at least two modules. Embodiments described herein are generally depicted in FIGS. 1-5B. A first grinding module can include a first chamber for herb product, the first chamber having a first chamber geometry, a center post, and a first set of grinding elements. A second grinding module can include a second chamber that rotatably engages with the first chamber, the second chamber having a second chamber geometry and a second set of grinding elements. The second set of grinding elements can be arranged to interact with the first set of grinding elements to grind herb product disposed in the first and/or second chamber when the second module rotates relative to the first module around an axis defined by the center post.

In some implementations, the center post of the first module includes a first engagement mechanism (e.g., a first magnet) that rotatably engages with a second engagement mechanism (e.g., a second magnet) in the second module in a manner that defines an axis of rotation and permits rotation of the first module with respect to the second module around that axis. For example, when the first and second modules are engaged in the grinding configuration, magnets hold the centers of the chambers together strongly but permit free rotation. Alternatively, any other suitable engagement mechanisms can be used. One of the modules can also be sized to fit snugly within the other module to effectively form a single closed grinding chamber, which can substantially prevent herb product from exiting the first and second chambers during grinding (e.g., an outer diameter of the first reservoir geometry is slightly smaller than an inner diameter of the second reservoir geometry, such that the first reservoir geometry is at least partially nested within the second reservoir geometry when the modules are engaged). In certain implementations, the chamber geometries can further define and/or constrain rotation of the respective modules. For example, each chamber geometry is substantially cylindrical, so that the inner diameter of one grinding module effectively guides rotation of the other grinding module nested therein. Other implementations can include any other features to help define, constrain, and/or otherwise affect the engagement and/or rotation of the modules relative to each other. For example, one or both grinding modules can include one or more o-rings (e.g., Teflon-coated, or the like), bearings, threading, spring-loaded features, friction-fit features, etc.

The grinding modules can include a number of features to facilitate grinding and/or related functionality. For example, as illustrated, each of the grinding modules includes a chamber having a substantially cylindrical shape defining an internal grinding region. In some implementations, the chambers can be sized to hold an amount of herb material predetermined to correspond with capacity of a particular type of smoking implement (e.g., an amount needed to pack a particular size of bowl of a particular type of pipe). Within each grinding region, there can be a set of grinding teeth (e.g., four teeth in one module and six in the other), each having a substantially diamond cross-section. Other numbers and shapes can be used, depending on the type of material being ground, the size of the grinding regions, the sizes of the teeth, and/or other factors. Each grinding region can be defined by the inside of a chamber wall, which can provide specific functionality. For example, as illustrated, the inside of the chamber wall of one grinding region is designed to interface with the outside of the chamber wall of the other grinding region (e.g., to constrain rotational movement and to provide a closed grinding environment); while the inside of the chamber wall of the other grinding region has a number of concave elements (e.g., eight pits or indents around the outside of the grinding region) designed to help move herb product into the teeth during grinding and to help reduce the amount of ground product that becomes trapped along the wall and between the wall and the teeth during grinding. For example, the teeth can be positioned to coincide with some or all vertices of the concave elements, so that herb product in the chamber tends to be forced along the concave element into the path of the teeth, while also minimizing the sizes of regions falling between a tooth and a wall that could potentially trap herb product. Further, some implementations of the grinding regions include center posts that also include concave elements. For example, the center post can have a generally rectangular, triangular, or other cross section wherein the walls are concave and/or include concave elements designed to help move herb product into the teeth during grinding and to help reduce the amount of ground product that becomes trapped along the wall and between the wall and the teeth during grinding.

Some embodiments of the grinding modules include handle regions that interface with the chambers. For example, the handle region of a grinding module can be coupled with its chamber, the handle region and chamber can be formed as a single piece (e.g., machined from a single piece of stock material, molded with a single mold, or otherwise singularly formed), or the handle region and chamber can be otherwise permanently, removably, and/or otherwise interfaced in any other suitable manner. In the illustrated embodiment, the handle regions of the two grinding modules have substantially complementary shapes so that the handles can effectively line-up and form a single “handle” in an idle configuration. Some implementations of the handles are sized and shaped to provide a desired ergonomic feel when using the grinding modules in the grinding configuration and when holding the modules in the idle configuration. For example, in the illustrated embodiment, the handle regions of the two grinding modules have substantially complementary shapes so that the handles can effectively line-up and form a single “handle” in an idle configuration. Further, as illustrated, the handle regions can be of an elongated shape (e.g., generally elliptical, rectangular, or otherwise) to facilitate rotation of the handles with respect to each other and to provide grinding torque. The handles and/or chambers can also be designed to facilitate evacuation of herb material from the chambers, for example, by knocking the grinding modules together. In some implementations, the chamber geometry includes features to facilitate use of certain tools. For example, certain inside radii can be selected to match the outer radius of a scraping tool or the like. Further, as illustrated, some implementations include additional features to facilitate engagement of the grinding modules in the idle configuration. For example, one or more latches, magnets, and/or other static or dynamic features can substantially restrict movement of one module with respect to the other when the modules are in the idle configuration (i.e., when the grinder is not in use).

While the grinding modules are described above as grinding in a particular manner, other features can be included to grind in additional and/or alternative manners. For example, some implementations can have a single elongated handle region, so that a user grinds herb product in the chamber by holding the chamber region of one module while rotating the handle region of the other module. Other implementations can include crank mechanisms, ratcheting mechanisms, electric mechanisms, and/or any other suitable grinding mechanisms. As described herein, the handle regions can also include various types of features that integrate other accoutrements, such as various smoking tools and/or accessories. Each integrated feature is described more fully below. Various configurations can have some or all of the integrated features described herein.

Integrated Lighter Compartment

In some embodiments, a lighter compartment is integrated into the handle region of one of the grinding modules. In the illustrated implementation, the lighter compartment can be configured to securely hold a lighter (e.g., of a standard size, of a particular make and/or model, etc.). For example, the lighter compartment can define a cavity that include slight tapering, one or more indents, and/or other static or dynamic features to receive and retain a butane lighter, miniature butane torch, etc. Accordingly, the lighter can be held in the lighter compartment by friction, latching, and/or any other suitable mechanism. The lighter compartment can also include geometric features, such as cutouts, to provide access to lighter mechanisms (e.g., to permit a user to activate the pump and flint of a lighter without removing the lighter from the compartment). Other implementations can be adaptable to multiple types and/or sizes of lighters. For example, the compartment can be designed to receive one or more types of lighters, torches, electronic heaters, etc. In some implementations, the lighter compartment forms an integrated lighter. For example, the lighter compartment can include a refillable fuel tank and ignition mechanism (e.g., a flint, electric sparker, etc.), an electric heater, etc. In some implementations, the lighter compartment is a cavity integrated into the handle region of a grinding module (e.g., machined, molded, formed, etc.); while in other implementations, the lighter compartment is formed from multiple components. For example, components can be removably coupled to provide access to the compartment, to facilitate installation or removal of the lighter, etc.

Integrated Tool Set

In some embodiments, one or more tools are integrated into one or more of the grinding modules in such a way that each tool can be selectively positioned in an idle (e.g., stored) and one or more use (e.g., exposed) configurations. For example, one of the grinding modules can include a set of tools, each coupled with the grinding module in a way that permits the tool to be stored at least partially within a body of the grinding module and exposed by pivoting a respective tool holder out from the body of the grinding module. In one implementation, one of the grinding modules includes one or more tool holders. Each tool holder is coupled with the grinding module via an axle that permits the tool holder to rotate around the axle from an idle position to one or more use positions. In one implementation, the axle is integrated into the grinding module in such a way that a magnetic end of the axle (e.g., some or all of the axle can be manufactured from magnetic material) interfaces with a magnetic element of the other grinding module when the two grinding modules are in the idle configuration to help hold the grinding modules in that configuration.

The tool holders can also include various features to facilitate or constrain movement between its positions. For example, each tool holder can include a lip, notch, or other geometry configured to permit a finger, fingernail, or the like to adjust the radial position of the tool holder; bevels, chamfers, radii, indents, outdents, or the like to help guide the tool holders into particular radial positions; etc. Some such features can additionally or alternatively be included in the grinding module. For example, the grinding module can include a tension spring mechanism that interfaces with chamfers on the tool holder to help stabilize the tool holders in predetermined radial positions.

Each tool holder can also include tool interface geometry for receiving and/or otherwise interfacing with a tool. For example, each tool holder can include a cavity or port (e.g., male or female) that receives one or more types of tools by friction fit, by threading, by latching, by magnetic coupling, or in any other suitable manner. Some implementations have multiple tools that can each fit into any of the tool holders, while other implementations are designed so that only certain tools fit into certain tool holders. Further, while some implementation permit tools to be removed from the tool holders (e.g., the tool holders are removable coupled with the tools), other implementations include fixed (e.g., permanent or substantially permanent) couplings between the tools and the tool holders. For example, in one implementation, the tools and tool holders are manufactured as a single piece.

Any suitable number and type of tool can be included. The illustrated embodiments show a reamer, a scraper, and a press. The reamer can be a sharp or blunt poking instrument. The scraper is illustrated to have the form of a small shovel, though any suitable shape and size is possible. The scraper and/or the reamer can be used, for example, for cleaning used herb product from the smoking implement (e.g., from a bowl, smoke hole, and/or other portion of the implement), cleaning ground product from the cavities of the grinding modules, etc.

The press is designed for packing herb product into a smoking implement (e.g., for packing ground tobacco into the bowl of a pipe). While smokers often use their fingers, the butts of their lighters, or some other blunt implement for such a purpose, such implements are typically sub-optimal for a variety of reasons, including size, shape, etc. The press is sized and shaped for improved packing. Further, some implementations are designed so that the press head pivots from a stored configuration to a use configuration. For example, as illustrated, the press head includes a cutout and an axle, and a press handle interfaces with the axle to permit the press head to pivot around the handle. The pivot mechanism is designed (e.g., sized and shaped) to mitigate inadvertent trapping of herb product in the pivot mechanism, which can frustrate its operation. Other types of pivot mechanism, other shapes and sizes of press heads, and other modifications are used in other implementations.

Other embodiments can include tools in addition to or instead of those discussed above. For example, other smoking tools can be included, such as a wire cleaner (e.g., a pipe cleaner), a precision cleaner (e.g., a rigid or malleable tool having loop, helix, hook, or any other shape for precision cleaning of a particular implement), a scoop, etc. Some implementations can include non-smoking related tools. For example, any useful type of tool can be integrated or designed to integrate within a tool holder, such as a screwdriver, flashlight, scissors, etc.

Integrated Accessory Storage Modules

In some embodiments, one or more accessory storage modules are integrated into one or more of the grinding modules. Some implementations of the grinding modules can include a spool configured to hold an amount of wick material. For example, the spool can be sized to hold a predetermined amount (e.g., twelve inches) of wick made from a certain material (e.g., hemp) and to a certain thickness (e.g., one millimeter). Other features can be included to support other with elements, such as other wick materials, thicknesses, wick tabs, etc. In some implementations, the spool sits within a cavity of the grinding module without being coupled with the grinding module. In other implementations, the spool can be coupled (e.g., removably) with an axle, track, or other feature of the grinding module to at least partially secure the spool in place. Some embodiments of the grinding module having the integrated wick spool include a port (e.g., a hole) sized to feed wick material from the spool inside the grinding module to the exterior of the grinding module. Certain implementations include further features, such as a securement (e.g., a notch, loop, band, hook, etc.) to removably secure the exposed wick material against the grinding module when not in use, a cutter to cut wick material, another securement to hold the wick near the lighter when being lit, etc.

Some embodiments include an integrated screen holder configured to hold one or more smoking screens. The illustrated screen holder includes a circular envelope sized to hold a number (e.g., three to five) standard screens and includes a cutout to permit access to the screens stored therein. In the illustrated implementation, the screen holder fits into the same cavity as the wick spool, with a cap that protrudes slightly from the cavity opening. The screen holder can be placed in a locked or unlocked position. For example, the screen holder can be shaped (e.g., notched), threaded, friction fit, or otherwise configured to be removable in the unlocked position and substantially secure in the locked position. In such an implementation, with the screen holder in the locked position, the protruding cap can be configured as a stop for the grinding modules. For example, when the grinding modules are in the idle configuration, the cap can protrude from one grinding module into a cavity of the other grinding module to help prevent the grinding modules from rotating with respect to each other; when the grinding modules are in the grinding configuration, the cap can protrude from one grinding module into the rotation region of the other grinding module to help prevent the grinding modules from fully rotating with respect to each other (e.g., restricting the rotation to 200 degrees). Further, the screen holder can be configured as a cap for the wick spool. For example, the wick spool is inserted into the cavity, after which the screen holder is inserted into the cavity and moved into its locked position. In alternative implementations, the screen holder can be placed in a different cavity from the wick spool, the spool or some other feature can be used as the stop for the grinding modules, and/or other changes can be made to the configurations while preserving some or all of the functionality.

Other embodiments can include other types of features. In one embodiment, a reservoir can be configured to hold some amount of herb product and to integrate into the grinding modules. For example, the reservoir can be sized to accommodate a same forma factor as that of the screen holder and/or the wick spool. The reservoir can be sized to fit a predetermined amount of ground or un-ground herb product (e.g., a proper amount for packing into a particular implement one or more times, etc.). The reservoir can also include additional features, such as a sieve, measurement markings, etc. Other embodiments can include an integrated ash tray, and/or any other useful smoking tool or accessory.

The methods disclosed herein include one or more actions for achieving the described method. The method and/or actions can be interchanged with one another without departing from the scope of the claims. In other words, unless a specific order of actions is specified, the order and/or use of specific actions can be modified without departing from the scope of the claims. The various operations of methods and functions of certain system components described above can be performed by any suitable means capable of performing the corresponding functions.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein can be utilized. Accordingly, the appended claims include within their scope such processes, machines, manufacture, compositions of matter, means, methods, or actions.

What is claimed is:

1. A modular herb grinder, comprising:
a first grinding module defining at least a portion of a grinding chamber;
a second grinding module cooperatively engaged with the first grinding module to define an enclosed grinding chamber;
a plurality of grinding elements extending with respect to the chamber;
wherein the first grinding module and the second grinding module are disposed for relative movement therebetween to cause the plurality of grinding elements to interact in the chamber for grinding of herb product disposed therein.

2. The modular herb grinder of claim 1, wherein at least one of the first grinding module or the second grinding module comprises an integrated accessory portion.

3. The modular herb grinder of claim 2, wherein the integrated accessory portion is selected from the group consisting of a lighter compartment, at least one integrated tool, an accessory storage module, and combinations thereof.

4. The modular herb grinder of claim 3, wherein the at least on integrated tool is selected from the group consisting of a reamer, a scraper, a press, and combinations thereof.

5. The modular herb grinder of claim 3, wherein the at least one integrated tool is moveable relative to the first or second grinding module between a stored and exposed configuration.

6. The modular herb grinder of claim 5, wherein the at least one integrated tool is rotatably coupled with the corresponding grinding module with which it is associated for movement between the stored and exposed configuration.

7. The modular herb grinder of claim 3, wherein the accessory storage module comprises a spool configured to hold an amount of wick material.

8. The modular herb grinder of claim 7, wherein the corresponding grinding module associated with the accessory storage module comprises a port through which the material can be access from the spool at an exterior of the grinding module.

9. The modular herb grinder of claim 3, wherein the accessory storage module comprises a screen holder.

10. The modular herb grinder of claim 9, wherein the screen holder is integrated into one of the first or second grinding modules to prevent movement of the grinding modules relative to one another.

11. The modular herb grinder of claim 3, wherein the accessory storage module comprises at least one of reservoir configured to hold a quantity of the herb product or an ash tray.

12. The modular herb grinder of claim 1, wherein the grinding elements comprise diamond shaped projections extending from an end wall of the chamber into an interior of the chamber.

13. The modular herb grinder of claim 12, wherein the grinding elements are disposed in offset concentric relation such that respective grinding elements extending from the first grinding module and the second grinding module move in relation to grinding elements extending from the other grinding module along concentric paths within the chamber.

14. The modular herb grinder of claim 1, wherein the first grinding module includes a first engagement member that engages with a second engagement member of the second grinding module.

15. The modular herb grinder of claim 14, wherein the first engagement member comprises a center post disposed along a central axis of the chamber.

16. The modular herb grinder of claim 15, wherein the first engagement member comprises a magnet that interacts with a magnetic portion of the second engagement member to secureably engage the first engagement member relative to the second engagement member.

17. The modular herb grinder of claim 16, wherein magnetic engagement between the first engagement member and the second engagement member allows for rotational movement of the first grinder module relative to the second grinder module relative to the central axis of the chamber.
